(19) United States
(12) Patent Application Publication
(10) Pub. No.: US 2010/0096554 A1
(43) Pub. Date: Apr. 22, 2010

(54) DEVICE AND METHOD FOR EVALUATING CLEANLINESS

(76) Inventors: Koji Shirota, Nagoya-shi (JP); Minoru Honda, Kitanagoya-shi (JP); Kiyoshi Morishige, Hirakata-shi (JP); Noboru Higashi, Kyotanabe-shi (JP)

Correspondence Address: KENYON & KENYON LLP, 1500 K STREET N.W., SUITE 700, WASHINGTON, DC, 20005, US

(21) Appl. No.: 12/517,221

(22) PCT Filed: Feb. 19, 2008
(86) PCT No.: PCT/JP2008/053136

§ 371 Date: Jun. 2, 2009

(30) Foreign Application Priority Data
Feb. 28, 2007 (JP) 2007-050349

(51) Int. Cl. G01J 5/02

(52) U.S. Cl. 250/341.8; 250/338.1

(57) ABSTRACT

The device comprises a floodlight unit and a receiver unit and a processing unit. The floodlight unit applies an infrared light to the surface of a work piece, and comprises a surface light source and a focusing lens. The receiver unit receives the infrared light reflected from the surface of the work piece, and comprises a receiver sensor and a filter, which passes the infrared light that has the wavelength which contaminants on the surface absorb. The processing unit evaluates the cleanliness of the surface of the work piece according to the absorbance of the infrared light reflected from the surface. And a receiving area of the reflected infrared light from the surface is set smaller than an applying area of the applied infrared light to the surface.

### TECHNICAL FIELD

The present invention relates to devices and methods for evaluating cleanliness of a surface of a workpiece in which infrared light is applied to the surface, light reflected from the surface is detected, an absorbance of the infrared light at the surface is computed by utilizing the detected light reflected from the surface, and then a cleanliness of the surface is evaluated by utilizing the absorbance and a predetermined relation between the absorbance and an amount of adhering contaminants on the surface.

### BACKGROUND ART

Generally, when assembling a cylinder block, a cylinder head and a chain case of the engine or the case of the transmission, sealing materials such as liquid gasket or the like are coated on the surfaces thereof in order to prevent oil leakage or the like.

The surfaces are formed by means of machining the cast parts using machining oil, so that the machining oil adheres on the surfaces. After machining, the machining oil is removed by cleaning the surfaces.

As mentioned above, the machining oil adhered on the faces is removed by cleaning. However, there is the case in which the machining oil remains on the faces after cleaning as the machining oil is removed incompletely or the case in which a cleaning agent remains on the faces.

The remained machining oil or the remained cleaning agent lowers the sealing performance of the sealing materials, which results in the oil leakage or the like. It is important to grasp whether the contaminants, such as the machining oil or the cleaning agent, remains on the surface where the sealing materials are coated (sealing surface).

Conventionally, the condition of the contaminants adhering to the sealing surface, in other words the cleanliness of the sealing surface, is measured as described below.

For example, an adhesive tape with a certain length and width is adhered to the sealing surface and the adhesive tape is peeled by pulling it upward in the substantially vertical direction with respect to the sealing surface, then the load required to peel the adhesive tape is measured. The cleanliness of the sealing surface is evaluated according to the measured load.

However, the above-mentioned method for evaluating the cleanliness of the sealing surface by measuring the peeling load of the adhesive tape is operated with hands, so that it is difficult to keep constant peeling angle or peeling speed when peeling the adhesive tape. Moreover, the adhesion strength of the adhesive tape toward the sealing surface highly depends on the temperature, so that even if the cleanliness of the sealing surface is same the measured value of the peeling load can be different because of the temperature. As a result, it is difficult to operate the measurement with accuracy and to evaluate appropriately.

Furthermore, the measurement operated with hands requires a long time, so that it is difficult to accomplish the measurement within the cycle time of the assembly process of the engine or transmission.

For example, solving the above-mentioned problems, JP-A-2002-350342 discloses a device for evaluating the cleanliness of the surface of the workpiece such as the sealing surface or the like.

JP-A-2002-350342 discloses the device, comprising: a floodlight, having an infrared light generator and applying infrared light to the surface of the workpiece; and a receiver, receiving the infrared light reflected from the surface of the workpiece with an adhesion of contaminants, in which detects an absorbance of the infrared light and measures a cleanliness of the surface of the workpiece according to the absorbance. In this case, the device only detects the infrared light, having a wavelength, which is absorbed by CH bond that is numerously included in organic molecules. Thus, the contaminants consisted of the organic molecules can be detected.

### DISCLOSURE OF INVENTION

### Problems to be Solved by the Invention

As disclosed by JP-A-2002-350342, the conventional device generally uses a point light source as the infrared light generator, wherein applying the infrared light to the surface of the workpiece, receiving the infrared light reflected from the surface of the workpiece with the adhesion of the contaminants, detecting the absorbance of the infrared light, and measuring the cleanliness of the surface of the workpiece according to the absorbance. The infrared light applied from the point light source is gathered into very narrow area on the surface of the workpiece and the receiving area of the infrared light is set as same size as the applying area of the infrared light from the point light source. So, even if the length or angle between the workpiece and the device changes a little, the detected absorbance of the infrared light changes a lot. Consequently, the cleanliness of the surface of the workpiece cannot be evaluated appropriately. (For example, an allowable change of length between the workpiece and the device is about plus or minus 0.5 mm.)

Particularly, with respect to the conventional device, when evaluating the cleanliness of the surface of the workpiece by applying the infrared light, the workpiece of measuring object mainly designates a semi-conductor substrate or the like, wherein roughness of the surface thereof is small and the surface thereof is a substantially mirror surface. The workpiece is high-precisely positioned and set on the stage of the large-scale stationary apparatus, and the absorbance of the infrared light is measured with the floodlight unit and receiver unit, which is each positioned high-precisely with respect to the workpiece. So, a variation of the length or angle between the surface of the workpiece and the apparatus rarely become the issue. However, if the workpiece designates a cast part that is a part of the engine or the transmission, which is heavy and large-scale and is formed in the complex shape, then it is difficult to accomplish the measurement while setting the workpiece on the stage of the apparatus and keeping the relation of the disposition between the surface of the workpiece, the floodlight and the receiver. As a result, it is difficult to secure the appropriate evaluation.

The objective of the present invention is to provide the device and method for evaluating the cleanliness of the surfaces enabled to measure the absorbance of the infrared light with accuracy and to evaluate the cleanliness of the surface of the workpiece easily and appropriately even if the workpiece is large-scale and formed in the complex shape such as the parts of the engine or the transmission, etc.

### Means of Solving the Problems

The first aspect of the present invention is a device for evaluating a cleanliness of a surface of a workpiece, comprising:

a floodlight unit, having a surface light source and a lens, said surface light source applies infrared light to the surface, and said lens focuses the infrared light;

a receiver unit for detecting a light reflected from the surface, having a filter and a receiver, said filter passes the infrared light that has wavelength which contaminants on the surface absorb, and said receiver receives the infrared light reflected from the surface, wherein a receiving area of the infrared light reflected from the surface is set smaller than an applying area of the infrared light applied from the floodlight unit to the surface; and
a processing unit for computing an absorbance of the infrared light at the surface by utilizing the infrared light reflected from the surface and for evaluating the cleanliness of the surface by utilizing the absorbance and a predetermined relation between an amount of adhering contaminants on the surface and the absorbance.

Thus, the device can prevent the variation of intensity of the infrared light received by the receiver unit, caused by the change of the length or angle between the device and the workpiece or by the variable factor such as the condition of the surface of the workpiece. In other words, the device can prevent the variation of the absorbance computed by the processing unit. Moreover, the device can evaluate the cleanliness of the surface of the workpiece with high-robustness.

As a result, an appropriate evaluation of the cleanliness can be easily achieved even if the workpiece is large-scale structure and formed in the complex shape, such as the cylinder block, the mission case or the like, in which it is difficult to keep the attitude of the workpiece toward the device, such as the length or angle between the device and the surface of the workpiece.

Preferably, the size of the receiving area is adjustable in accordance with the size of the evaluating area of the surface.

Thus, the device can evaluate the cleanliness on the surfaces of the workpieces of various sizes, so that the flexibility of the device can be improved.

Preferably, the size of the applying area is set in accordance with a shifting length of the receiving area on the surface with respect to the applying area caused by an allowable amount of change of the distance among the floodlight unit, the receiver unit and the surface.

Thus, when the change of length is smaller than the allowable change of length, the receiving area can be absolutely smaller than the applying area. So, the variation of the intensity of the infrared light received by the receiver unit after reflection from the surface can be prevented. Moreover, an appropriate evaluation of the cleanliness can be easily achieved.

The second aspect of the present invention is a method for evaluating a cleanliness of a surface of a workpiece, comprising:

applying infrared light focused by a lens to the surface from a surface light source;

receiving light reflected from the surface, wherein the infrared light is passed through a filter which passes the infrared light that has wavelength which contaminants on the surface absorb and wherein a receiving area of the infrared light reflected from the surface is set smaller than an applying area of the infrared light applied from the floodlight unit to the surface;

computing an absorbance of the infrared light at the surface by utilizing the infrared light reflected from the surface; and

evaluating the cleanliness of the surface by utilizing the absorbance and a predetermined relation between an amount of adhering contaminants on the surface and the absorbance.

Thus, the method can prevent the variation of intensity of the infrared light received by the receiver unit, caused by the change of the length or angle between the device and the workpiece or by the variable factor such as the condition of the surface of the workpiece. In other words, the device can prevent the variation of the absorbance computed by the processing unit. Moreover, the device can evaluate the cleanliness of the surface of the workpiece with high-robustness.

As a result, an appropriate evaluation of the cleanliness can be easily achieved even if the workpiece is large-scale structure and formed in the complex shape, such as the cylinder block, the mission case or the like, in which it is difficult to keep the attitude of the workpiece toward the device, such as the length or angle between the device and the surface of the workpiece.

Preferably, the size of the receiving area is adjustable in accordance with the size of the evaluating area of the surface.

Thus, the method can evaluate the cleanliness on the surfaces of the workpieces of various sizes, so that the flexibility of the device can be improved.

Preferably, the size of the applying area is set in accordance with a shifting length of the receiving area on the surface with respect to the applying area caused by an allowable amount of change of the distance among the floodlight unit, the receiver unit and the surface.

Thus, when the change of length is smaller than the allowable change of length, the receiving area can be absolutely smaller than the applying area. So, the variation of the intensity of the infrared light received by the receiver unit after reflection from the surface can be prevented. Moreover, an appropriate evaluation of the cleanliness can be easily achieved.

### EFFECT OF THE INVENTION

According to the present invention, the device and method can evaluate the cleanliness of the surface of the workpiece with high-robustness. Furthermore, even if the workpiece is large-scale structure and formed in the complex shape such as the cylinder block, the mission case or the like, in which it is difficult to keep the attitude of the workpiece such as the length or angle between the device and the surface of the workpiece, an appropriate evaluation of the cleanliness can be easily achieved.

### BRIEF DESCRIPTION OF DRAWINGS

FIG. 1 is a side sectional view of a device for evaluating a cleanliness of a surface of a workpiece.

FIG. 2 is a side sectional view of traveling length of infrared light in contaminants.

FIG. 3 is a view showing a relation between an amount of adhering the contaminants on the surface of the workpiece and an absorbance.

FIG. 4 is a view showing a relation of the dispositions between an applying area and a receiving area if the size of the applying area is set as the same size as that of the receiving area, when a distance between a sensor head unit and the workpiece is set in a proper distance, and when the distance is larger than the proper distance.

FIG. 5 is a view showing a relation of the dispositions between an applying area and a receiving area if the size of the applying area is set larger than that of the receiving area, when a distance between a sensor head unit and the workpiece is set in a proper distance, and when the distance is larger than the proper distance.

FIG. 6 is a side sectional view showing an embodiment of the device for evaluating the cleanliness of connections of a cylinder block, a cylinder head with a chain case.

### THE BEST MODE FOR CARRYING OUT THE INVENTION

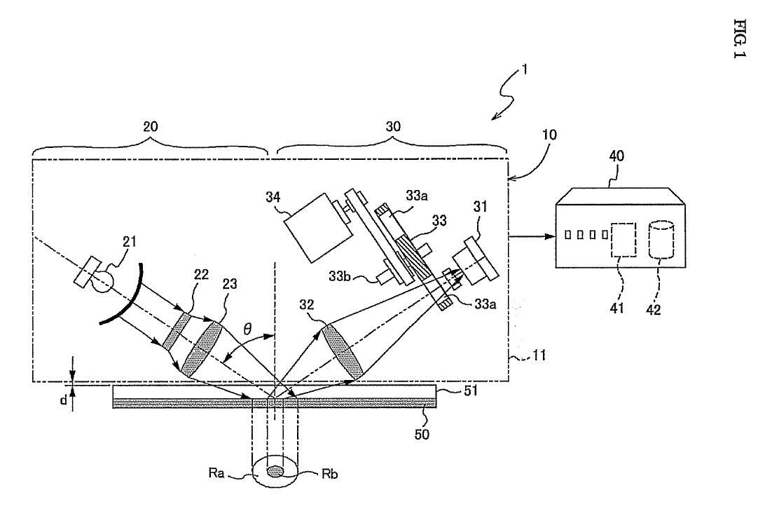

A device 1 for evaluating cleanliness, shown in FIG. 1, is the device for evaluating the cleanliness of the surfaces of the parts, which construct the engine or transmission. The device 1 comprises a sensor head unit 10, containing a floodlight unit 20 and a receiver unit 30 and a processing unit 40. The floodlight unit 20 applies an infrared light to the surface of a workpiece 50. The receiver unit 30 receives the infrared light reflected from the surface of the workpiece 50. The processing unit 40 evaluates the cleanliness of the surface of the workpiece 50 according to an absorbance of the infrared light reflected from the surface detected by the sensor head unit 10.

The floodlight unit 20 and the receiver unit 30 are contained in a case 11.

The floodlight unit 20 comprises a surface light source 21, a p-polarizer 22 and a focusing lens 23. The surface light source 21 having a certain area applies the infrared light. The p-polarizer 22 passes only p-polarized light, that is, the infrared light of which the direction of the electric field vector turns to the inside of the area made on the surface of the workpiece 50 by the incident light and the reflected light in the whole infrared light applied to the surface. The focusing lens 23 focuses the infrared light applied by the surface light source 21.

The receiver unit 30 comprises a receiver sensor 31, a focusing lens 32 and a filter 33. The focusing lens 32 focuses the infrared light reflected from the surface of the workpiece 50. The receiver sensor 31 detects the infrared light focused by the focusing lens 32. The filter 33 is disposed between the receiver sensor 31 and the focusing lens 32. The filter 33 only passes the infrared light that has a certain wavelength within the reflected light.

The filter 33 is composed of a discal member and a plurality of filters 33a disposed circumferentially on the discal member. The filter 33 can be rotated around an axis 33b with a motor 34.

The plurality of filters 33a are configured as the filters, which can pass the infrared lights that have the mutually different wavelengths. One of the plurality of filters 33a is the filter, which can pass the infrared light of which wavelength is within the vibrational wavelength range of CH bond included in the organic materials, in other words, the filter, which can pass the infrared light that has wavelength which the CH bond absorbs.

Here, the peak of the wavelength that CH bond absorbs is 3.4 micrometers.

The processing unit 40 comprises a computer unit 41 and a storage unit 42. The computer unit 41 computes the absorbance at the surface of the workpiece 50 according to the reflected light detected by the receiver sensor 31 and evaluates the cleanliness of the surface of the workpiece 50 according to the computed absorbance. The storage unit 42 stores the predetermined relation between an amount of adhering contaminants 51 on the surface of the workpiece 50 and the absorbance.

In this embodiment, the workpiece 50, for example, designates a cylinder block, a cylinder head or a chain case of engines, or a mission case of transmissions. The contaminant 51 of measuring object adhered on the workpiece 50, for example, designates a machining oil utilized when machining or a cleaning agent utilized when cleaning or removing the machining oil.

Moreover, when the device 1 of the present invention evaluates the cleanliness of the surface of the workpiece 50, the sensor head unit 10 is set in such a way that the sensor head unit 10 and the workpiece 50 is separated by a certain distance d.

The device 1, as described above, evaluates the cleanliness of the surface of the workpiece 50 as following.

First, the surface light source 21 applies the infrared light, which has a certain area size. The infrared light becomes p-polarized light passing through the p-polarizer 22. Second, the infrared light is focused, passing through the focusing lens 23. Then, the focused infrared light is applied to an applying area Ra, which has a certain area, on the surface of the workpiece 50.

The infrared light applied to the area Ra is reflected on the surface of the workpiece 50. The reflected infrared light is focused, passing through the focusing lens 32. The focused infrared light is received by the receiver sensor 31, after passing through the filter 33. Here, the infrared light is received in a receiving area Rb.

In this case, the infrared light that has a certain wavelength is only received by the receiver sensor 31 as the received infrared light passes through the filter 33.

The applying area Ra, which is the applying area of the infrared light from the floodlight unit 20 to the surface of the workpiece 50, is set larger than the receiving area Rb, which is the receiving area of the infrared light at the receiver unit 30. For example, the applying area Ra is set ten times or more as large as the receiving area Rb.

The intensity of the reflected infrared light is input to the processing unit 40. The computer unit 41 computes the absorbance according to the reflected infrared light.

Here, the absorbance of the infrared light is expressed, as shown in [formula I],” by Beer-Lambert law.

Absorbance=−log(I/Io)=k×c×L [formula 1]

Here, I is the intensity of the reflected infrared light of the workpiece 50 of measuring object. In other words, I is the intensity of the reflected infrared light from the surface of the workpiece 50 adhering the contaminants 51. Io is the intensity of the reflected infrared light from a standard workpiece, which has a clean surface without adhering the contaminants 51. k is the coefficient. c is the concentration of the contaminants 51. L is the traveling length of the infrared light through the contaminants 51.

The traveling length L is, as shown in FIG. 2, increased a length L1, which is the length of the incident light applied from the floodlight unit 20 traveling through the contaminants 51, and a length L2, which is the length of the reflected light received by the receiver unit 30 traveling through the contaminants 51.

That is to say, the absorbance can be computed by [formula 1] in the computer unit 41.

For example, if the received infrared light received by the receiver unit 30 has the wavelength which the CH bond absorbs, the received infrared light is absorbed by the C11 bond contained in the contaminants 51 when reflecting at the surface of the workpiece 50. Thus, the intensity of the reflected infrared light received by the receiver sensor 31 becomes smaller, and then the intensity I of the reflected infrared light of the workpiece 50 becomes small, however, the intensity Io of the reflected infrared light from the standard workpiece is constant. So, the absorbance, computed as above-mentioned, becomes larger.

Moreover, in this embodiment, the contaminant 51 designates the machining oil or the cleaning agent, so that the concentration of the contaminants 51 can be said to be constant. Thus, the absorbance of the infrared light can be said to be proportional to the traveling length L by [formula 1].

Furthermore, when the amount of adhering contaminants 51 to the surface of the workpiece 50 is large, the thickness of the contaminants 51 becomes larger, so that the traveling length L of the infrared light through the contaminants 51 becomes larger. Thus, the traveling length L can be said to be proportional to the amount of adhering contaminants 51.

Finally, when the amount of adhering contaminants 51 is small, the cleanliness of the surface of the workpiece 50 is high. Thus, the amount of adhering contaminants 51 nearly equals the cleanliness of the surface of the workpiece 50.

Consequently, it can be said that the relation is realized, (the absorbance of the infrared light)∝(the amount of adhering contaminant 51)≈(the cleanliness of the surface of the workpiece 50). If the relation between (the absorbance of the infrared light) and (the amount of adhering contaminants 51) is determined in advance, then (the cleanliness of the surface of the workpiece 50) can be measured according to the absorbance computed by the computer unit 41 and can be evaluated quantitatively.

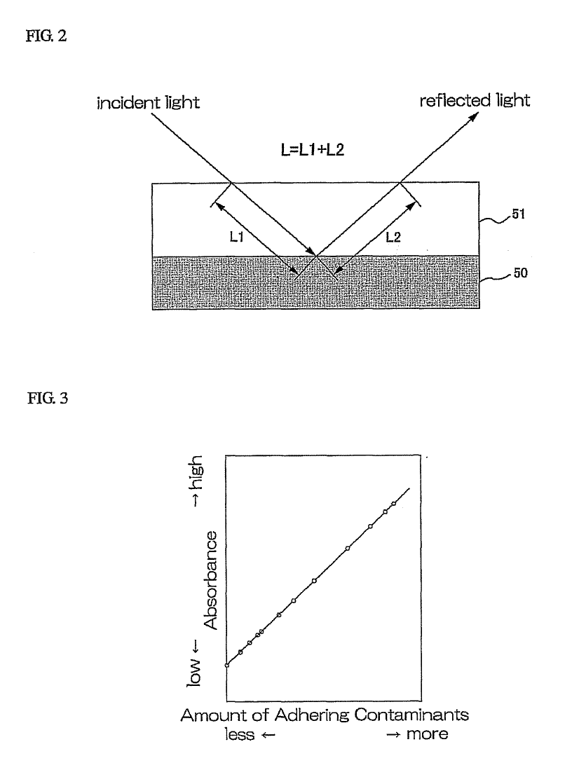

In the processing unit 40, “the relation between (the absorbance of the infrared light) and (the amount of adhering contaminant 51),” shown in FIG. 3, is determined in advance and is stored in the storage unit 42.

In the computer unit 41, the absorbance, computed as above-mentioned, is applied to “the relation between (the absorbance of the infrared light) and (the amount of adhering contaminant 51)” stored in the storage unit 42 and the amount of the adhering contaminants 51 is computed, and then the cleanliness of the surface of the workpiece 50 is evaluated according to the computed amount of the adhering contaminants 51.

In this case, the cleanliness of the surface of the workpiece 50 can be expressed by the concrete value, the level or the like. The cleanliness of the surface of the workpiece 50 can be compared with a certain threshold value.

According to FIG. 3, the larger the absorbance becomes, the larger the amount of adhering contaminant 51 becomes and the lower the cleanliness of the surface of the workpiece 50 becomes.

In the device 1, as above-mentioned, for evaluating the cleanliness of the surface of the workpiece 50, an incident angle θ of the incident light from the surface light source 21 to the workpiece 50 is set in an angle inclined by Brewster's angle with respect to the perpendicular line.

Here, Brewster's angle is the incident angle, in which reflection rate of the p-polarized element in the infrared light at the surface of the contaminants 51 becomes zero when the infrared light from the surface light source 21 is incident into the contaminants 51. Brewster's angle is a characteristic value that is determined by the refractive index between air and the contaminants 51. In this embodiment, Brewster's angle is, for example, 56 degrees.

Thus, in the device 1 for evaluating the cleanliness according to the present invention, the incident angle of the incident light from the surface light source 21 is set in Brewster's angle and the p-polarized light, passing through the p-polarizer 22, is incident on the surface of the workpiece 50. Therefore, it can be prevented that the incident light reflects on the surface of the contaminants 51 and that the multiple reflection in the layer of the contaminants 51. So, the error of absorption of the infrared light caused by these reflections, such as the reflections on the surface or the multiple reflections, can be reduced.

As a result, the precision of the evaluation of the cleanliness on the surface of the workpiece 50 can be improved.

Moreover, the infrared light, applied from the surface light source 21 to the surface of the workpiece 50, is focused by the focusing lens 23, and then the focused infrared light, having a large applying area Ra, is incident onto the surface of the workpiece 50.

Therefore, if the length or angle between the surface lights source 21 and the workpiece 50, in other words, the distance d or angle between the sensor head unit 10 and the workpiece 50 changes a little, then the intensity of the reflected light rarely changes. As a result, the value of the absorbance rarely varies, in comparison with the case in which the intensity of the reflected light changes much when the infrared light is applied from the point light source.

Furthermore, the focused infrared light is applied to the large area, so that the directivity of the infrared light becomes low in comparison with the case in which the parallel light is applied. So, the effect of the roughness of the surface of the workpiece 50 and the tool marks on the surface of the workpiece 50 can be prevented, and then the variation of the absorbance can be prevented.

In the device 1 for evaluating the cleanliness according to the present invention, the applying area Ra is set larger than the receiving area Rb, so that the variation of the intensity of the reflected light received by the receiver sensor 31 can be prevented even if the distance d between the sensor head unit 10 and the workpiece 50 changes.

On one hand, in the conventional device for evaluating the cleanliness, in which the infrared light is applied from the floodlight unit to the surface of the workpiece, the reflected infrared light from the surface of the workpiece is received at the receiver unit, and then the cleanliness of the surface of the workpiece is evaluated, the applying area Ra is generally set as the same size as the receiving area Rb.

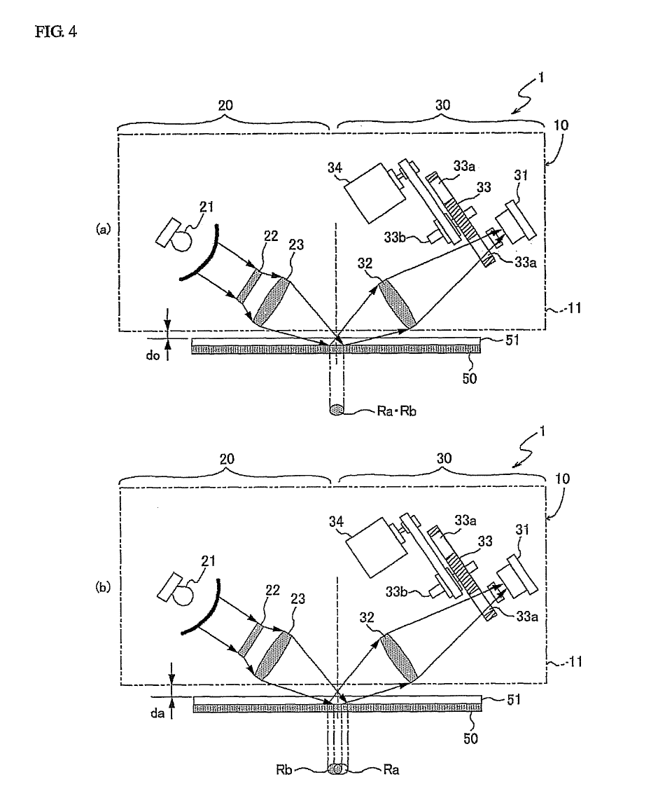

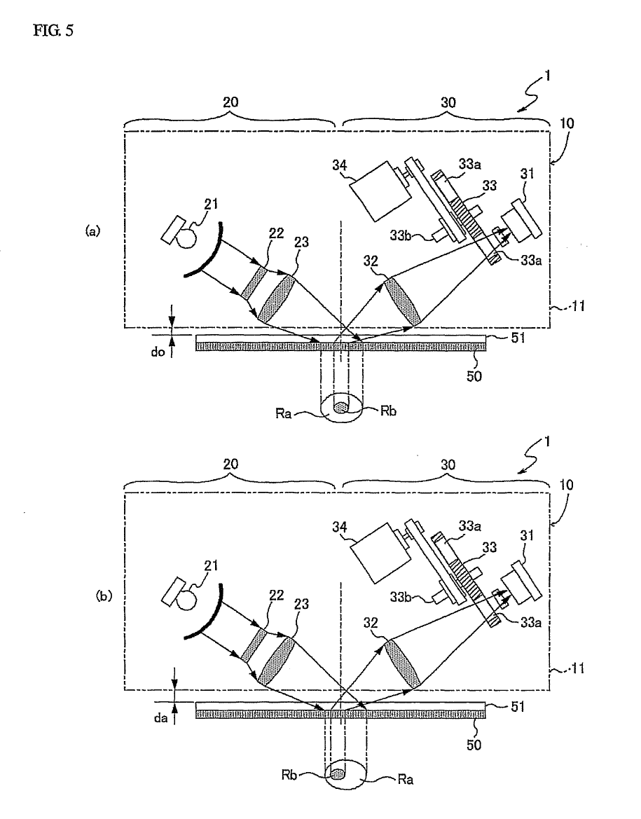

As mentioned above, if the applying area Ra is set as the same size as the receiving area Rb and the distance d between the sensor head unit 10 and the workpiece 50 is appropriately set in a proper distance d₀, as shown in FIG. 4(a), then the positions of the applying area Ra and the receiving area Rb are kept same. So, all of the infrared light, except for the infrared light absorbed by the contaminants 51, applied from the floodlight unit 20 can be received at the receiver unit 30.

However, as shown in FIG. 4(b), if the applying area Ra is set as the same size as the receiving area Rb and the distance d between the sensor head unit 10 and the workpiece 50 is set in a distance da, which is larger than the proper distance d₀, then the positions of the applying area Ra and the receiving area Rb are displaced each other. So, the infrared light applied from the floodlight unit 20 can be partly received at the receiver unit 30.

Thus, when the applying area Ra is set as the same size as the receiving area Rb and the distance d between the sensor head unit 10 and the workpiece 50 changes a little, the amount of receiving infrared light, received by the receiver sensor 31, becomes less than the case where the distance d is set in the proper distance d₀. As a result, there is a variation in the intensity of the reflected infrared light received by the receiver sensor 31.

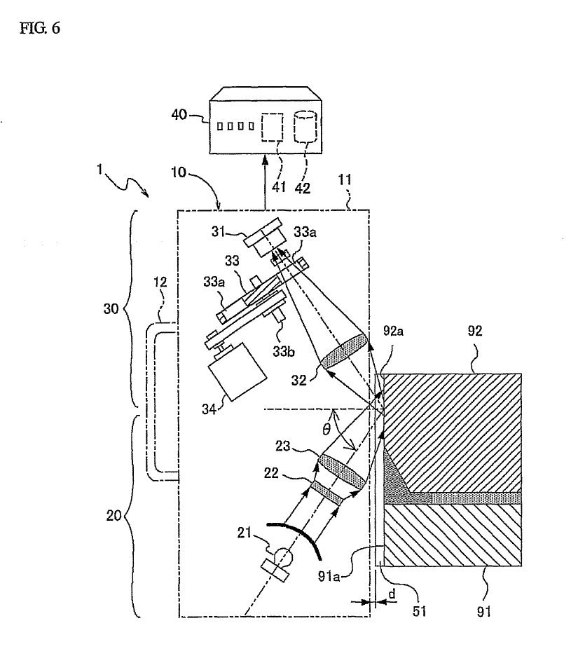

On the other hand, in the device 1 for evaluating the cleanliness according to the present invention, the applying area Ra is set larger than the receiving area Rb. As shown in FIG. 5(a), if the distance d between the sensor head unit 10 and the workpiece 50 is kept setting as the proper distance d₀, then all of the receiving area Rb is included in the applying area Ra. So, all of the infrared light, except for the infrared light absorbed by the contaminants 51, applied from the floodlight unit 20 can be received at the receiver unit 30.

Furthermore, as shown in FIG. 5(b), if distance d between the sensor head unit 10 and the workpiece 50 is set in a distance da, which is larger than the proper distance d₀, then the positions of the applying area Ra and the receiving area Rb are displaced each other.

However, the applying area Ra is set larger than the receiving area Rb. So, even if the positions of the applying area Ra and the receiving area Rb are displaced each other, all of the receiving area Rb is included in the applying area Ra. So, all of the infrared light, except for the infrared light absorbed by the contaminants 51, applied from the floodlight unit 20 can be received at the receiver unit 30.

Thus, when the applying area Ra is set larger than the receiving area Rb and the distance d between the sensor head unit 10 and the workpiece 50 varies, the amount of receiving infrared light, received by the receiver sensor 31, does not change. As a result, the variation in the intensity of the reflected infrared light received by the receiver sensor 31 can be prevented.

The size of the applying area Ra is set in accordance with a shifting length of the receiving area Rb on the surface of the workpiece 50 with respect to the applying area Ra caused by an allowable change of distance among the floodlight unit 20, the receiver unit 30 and the surface of the workpiece 50, which is the change of the distance d between the sensor head unit 10 and the workpiece 50. Thus, even if the receiving area Rb shifts with respect to the applying area Ra caused by the change of the distance d, all of the receiving area Rb can be included in the applying area Ra.

That is to say, at least the semimajor axis of the applying area Ra formed in an elliptical shape, in which the direction of the major axis thereof is the same as the direction of applying the infrared light, is set longer than the semimajor axis of the receiving area Rb in accordance with the shifting length of the receiving area Rb with respect to the applying area Ra caused by the change of the distance d from the proper distance d₀. As a result, the applying area Ra is set larger than the receiving area Rb.

For example, X is an amount of change of the distance d, Y is an amount of shifting the receiving area Rb with respect to the applying area Ra and θ a is a supplementary angle of the incident angle θ. The relation “tan(θa)=X/Y” is realized.

In this embodiment, the incident angle θ is Brewster's angle, 56 degrees, so that the supplementary angle θ a becomes 34 degrees. The amount X, which is the allowable amount of change of the distance d from the proper distance d₀, can be set in plus or minus 4 mm. When the distance d is, for example, enlarged by 4 mm more than the proper distance d₀, in other words the amount X is set in 4 mm, the amount Y becomes about 6 mm (exactly, 5.97 mm) by using the above-mentioned relation.

Therefore, the semimajor axis of the applying area Ra is, at least, formed in longer by the amount Y (in this embodiment, about 6 mm) than the semimajor axis of the receiving area Rb.

Moreover, the variations that cause the shifting of the receiving area Rb with respect to the applying area Ra, such as the variation in the angle (e.g. the incident angle θ) between the sensor head unit 10 and the workpiece 50, can occur in addition to the variation in the distance d. Thus, it can be possible to set the semimajor axis of the applying area Ra, adding a certain length to the length of the semimajor of the receiving area Rb that has already added the amount Y.

Furthermore, the semiminor axis of the applying area Ra can be set longer than the semiminor axis of the receiving area Rb, so that the receiving area Rb is surely included in the applying area Ra.

In this embodiment, the semimajor and semiminor axis of the receiving area Rb are respectively set in 4 mm and 2.5 mm and the semimajor and semiminor axis of the applying area Ra are respectively set in 15 mm and 7.5 mm. The area of the applying area Ra is about ten times (exactly, 11.25 times) as large as that of the receiving area Rb. Thus, even if the amount of change of the distance d from the proper distance d₀ is the maximum (plus or minus 4 mm), the receiving area Rb can be surely included in the applying area Ra.

As mentioned above, the size of the applying area Ra is set in accordance with the amount of change of the receiving area Rb with respect to the applying area Ra caused by the variation in the distance d between the sensor head unit 10 and the workpiece 50. Thus, when there occurs the great variation in the distance d within the allowable amount of change of the device 1, the receiving area Rb can be surely included in the applying area Ra. As a result, it can be prevented to occur the variation in the intensity of the reflected light received by the receiver sensor 31, and then the appropriate evaluation of the surface of the workpiece 50 can be easily accomplished.

As described above, the device 1 for evaluating the cleanliness according to the present invention can prevent the variation in the intensity of the reflected light received by the receiver sensor 31 caused by the uncertain variable elements such as the surface condition of the workpiece 50 or the variation in the dispositions of the sensor head unit 10 and the workpiece 50, for example the distance or angle between the sensor head unit 10 and the workpiece 50. In other words, the device 1 can prevent the variation in the computed absorbance, so that the evaluation of the cleanliness can be accomplished with high-robustness.

As a result, even if the workpiece 50 is a large-scale structure and formed in the complex shape such as the cylinder block, the mission case or the like, in which it is difficult to keep the attitude of the workpiece 50 toward the device 1 such as the length or angle between the device 1 and the surface of the workpiece 50, the appropriate evaluation of the cleanliness can be easily achieved.

For example, the variation in the absorbance value, caused by the change of the distance d between the sensor head unit 10 and the workpiece 50, is compared below. In the case where the point light source applies the infrared light to the surface of the workpiece 50 and the size of the applying area Ra is set as same size as that of the receiving area Rb, the variation in the computed absorbance goes beyond the allowable range when the variation in the distance d goes beyond the range of plus or minus 0.5 mm. In the case of the device 1 according to the present invention where the surface light source 21 applies the infrared light to the broad area on the surface, focusing the infrared light and the size of the applying area Ra is set larger than that of the receiving area Rb, the variation of the computed absorbance can be included in the allowable range as long as the variation in the distance d is within the range of plus or minus 4

As shown in FIG. 6, the device 1, for example, can be used for evaluating the cleanliness of attaching surfaces 91a and 92a of a chain case (not shown) in a connection part of the chain case, a cylinder block 91 with a cylinder head 92.

In FIG. 6, the infrared light is applied to the attaching surface 92a in the connection part.

The sealing materials are coated on the attaching surfaces 91a and 92a to seal between them and the chain case. Here, there is the case where the contaminants 51, which lower the sealing performance of the sealing materials, are adhered on the attaching surfaces 91a and/or 92a. The contaminant 51 is, for example, the machining oil, engine oil or the like which is included in the machining coolant or is the detergent for cleaning the machining coolant.

Accordingly, the cleanliness of the attaching surfaces 91a and 92a are evaluated using the device 1, so that the sealing performance of the connection part can be secured.

When the cleanliness of the attaching surface 91a or 92a is evaluated, as mentioned above, the infrared light is applied to the attaching surfaces 91a or 92a from the surface light source 21, passing through the p-polarizer 22 and the focusing lens 23, and the reflected infrared light from the attaching surface 91a or 92a is received by the receiver sensor 31, passing through the focusing lens 32 and the filter 33, and then the cleanliness of the attaching surface 91a or 92a is evaluated using the processing unit 40 in accordance with the intensity of the received infrared light.

In this case, one of the filters 33a of the filter 33 is configured as the filter, which can pass the infrared light that has wavelength which the CH bond absorbs. The infrared light that has wavelength which the CH bond absorbs is utilized as the object wavelength.

Thus, the absorbance is measured from the infrared light that has a certain wavelength, passing through the filter 33a, so that the processing time of evaluation can be shortened. As a result, within the manufacturing process of the workpiece 50, the cleanliness of the surfaces of all the workpieces 50 can be evaluated automatically in the manufacturing line.

The device 1 further comprises the filter 33a, which can pass the infrared light that has wavelength which the CH bond cannot absorb and shorter wavelength than the object wavelength, and comprises the filter 33a, which can pass the infrared light that has wavelength which the CH bond cannot absorb and longer wavelength than the object wavelength. In the device 1, the reflected infrared light is passed through the filters 33a, and then the shorter and longer wavelengths are used as reference wavelengths. Thus, the absorbance in question can be computed by using the absorbance of the object wavelength with respect to the reference wavelengths.

As mentioned above, the device 1 according to the present invention computes the absorbance by using the reference wavelengths in addition to the object wavelength, so that it is possible not to be affected by the surface conditions, such as the reflection rate or the like, of the workpiece 50 (e.g. the attaching surfaces 91a and 92a). As a result, the appropriate evaluation can be accomplished, computing the absorbance precisely.

Moreover, in the device 1 according to the present invention, the receiving area Rb by the receiver unit 30 is set smaller than the applying area Ra by the floodlight unit 20. The size of the receiving area Rb is adjustable in accordance with the size of the evaluating area of the surface of the workpiece 50 of measuring object (e.g. the attaching surfaces 91a and 92a). Here, the size of the receiving area Rb is adjusted less than that of the applying area Ra.

As mentioned above, in the device 1 according to the present invention, the size of the receiving area Rb is adjustable, so that the device 1 can evaluate the cleanliness of the workpieces of various sizes. As a result, the flexibility of the device 1 can be improved.

The device 1 further comprises a handle 12 for carrying the device 1. The handle 12 is attached to the case 11, so that operators can carry the device 1 with the handle 12.

As mentioned above, the device 1 is portable, so that even if the workpiece of measuring object is large-scale and is formed complexly, such as the cylinder block or the mission case, the device 1 can easily evaluate the cleanliness of the workpiece 50, as the device 1 is carried near the workpiece 50.

### INDUSTRIAL APPLICABILITY

According to the present invention, the device and method can be suitably applicable to devices and methods for evaluating the cleanliness of the surfaces of the workpieces.

1. A device for evaluating a cleanliness of a surface of a work-piece, comprising:
a floodlight unit, having a surface light source and a lens, said surface light source applies infrared light to the surface, and said lens focuses the infrared light;
a receiver unit for detecting a light reflected from the surface, having a filter and a receiver, said filter passes the infrared light that has wavelength which contaminants on the surface absorb, and said receiver receives the infrared light reflected from the surface, wherein a receiving area of the infrared light reflected from the surface is set smaller than an applying area of the infrared light applied from the floodlight unit to the surface; and
a processing unit for computing an absorbance of the infrared light at the surface by utilizing the infrared light reflected from the surface and for evaluating the cleanliness of the surface by utilizing the absorbance and a predetermined relation between an amount of adhering contaminants on the surface and the absorbance.

2. The device according to claim 1, wherein the size of the receiving area is adjustable in accordance with the size of the evaluating area of the surface.

3. The device according to claim 1, wherein the size of the applying area is set in accordance with a shifting length of the receiving area on the surface with respect to the applying area caused by an allowable amount of change of the distance among the floodlight unit, the receiver unit and the surface.

4. A method for evaluating a cleanliness of a surface of a work-piece, comprising:
applying infrared light focused by a lens to the surface from a surface light source;
receiving light reflected from the surface, wherein the infrared light is passed through a filter which passes the infrared light that has wavelength which contaminants on the surface absorb and wherein a receiving area of the infrared light reflected from the surface is set smaller than an applying area of the infrared light applied from the floodlight unit to the surface;
computing an absorbance of the infrared light at the surface by utilizing the infrared light reflected from the surface; and
evaluating the cleanliness of the surface by utilizing the absorbance and a predetermined relation between an amount of adhering contaminants on the surface and the absorbance.

5. The method according to claim 4, wherein the size of the receiving area is adjustable in accordance with the size of the evaluating area of the surface.

6. The method according to claim 4, wherein the size of the applying area is set in accordance with a shifting length of the receiving area on the surface with respect to the applying area caused by an allowable amount of change of the distance among the floodlight unit, the receiver unit and the surface.
